(19) United States
(12) Patent Application Publication
(10) Pub. No.: US 2015/0155100 A1
(43) Pub. Date: Jun. 4, 2015

(54) MULTI-LAYER CERAMIC CAPACITOR AND METHOD FOR MANUFACTURING THE SAME

(71) Applicant: TAIYO YUDEN CO., LTD., Taito-ku, Tokyo (JP)

(72) Inventor: Koichiro Morita, Takasaki-shi (JP)

(21) Appl. No.: 14/389,303

(22) PCT Filed: Nov. 13, 2012
(86) PCT No.: PCT/JP2012/079423

§ 371 Date: Sep. 29, 2014

(30) Foreign Application Priority Data
Mar. 30, 2012 (JP) 2012-079487

(51) Int. Cl. H01G 4/30; H01G 4/12; H01G 4/248; H01G 4/012

(52) U.S. Cl. CPC H01G 4/30; H01G 4/012; H01G 4/12; H01G 4/248

(57) ABSTRACT

A multi-layer ceramic capacitor includes dielectric layers and internal electrode layers alternately laminated with the dielectric layers, wherein the proportion of dielectric grains constituting a dielectric layer that exists in one-layer-one-grain form is greater than 50%, and the average value of an electrode-grain aspect ratio, which represents the ratio of the maximum length, which is perpendicular to the thickness direction, to the maximum thickness of electrode grains constituting an internal electrode layer, is greater than 3.

### TECHNICAL FIELD

The present invention relates to a multi-layer ceramic capacitor (MLCC) of small size and high capacitance achieved by high-density layering of dielectric layers, as well as a method for manufacturing the same.

### BACKGROUND ART

As digital electronic devices such as mobile phones become smaller and thinner, need for smaller chip dimensions and larger capacitance required for a multi-layer ceramic capacitor (MLCC) mounted on an electronic circuit board grow every year. In general, there is a relationship that capacitance decreases as a capacitor is downsized since the internal electrode area facing the dielectric layer is inevitably reduced. Therefore, a high-density layering technology to reduce the thickness of dielectric layer between the internal electrodes and to laminate many dielectric layers is essential to secure a capacitor's capacitance when downsizing chip dimensions.

When thickness of one dielectric layer is set to 1 μm or less to achieve high capacitance of a multi-layer ceramic capacitor, the dielectric layer thickness and the dielectric grain size become approximately equal and come close to the structure called “one-layer-one-grain”. In general, the closer the structure becomes to “one-layer-one-grain”, the more it is prone to poor electrical insulating properties and declining voltage endurance characteristics due to the reduced grain boundaries between the grains. This is because grain boundaries have higher insulating properties relative to dielectric grains, and grain boundaries serve to hinder oxygen vacancy migration (electrical field migration) occurring in an electrostatic field.

On the other hand, if dielectric grain sizes are reduced according to reduced thickness of the dielectric layers, the dielectric constant declines due to the size effect resulting in insufficient capacitance obtained from the capacitor as a whole. Therefore, a technique to prevent a loss of dielectric constant and secure the capacitance by sintering dielectric fine powder to increase grain size has been used for high-density layering technology of a ceramic capacitor.

For example, according to Patent Literature 1, when a dielectric layer is thin-layered to approximately 1 μm, the relative dielectric constant of over 6000 can be obtained by preparing a grain size of 0.1 to 0.2 μm using Ba₁₋ₓCaₓTiO₃ (also called “BCT”) as material powder being synthesized by substituting a part of BaTiO₃ with Ca, and allowing the dielectric grain size grow to 0.35 to 0.65 μm. In addition, it is disclosed that the insulating properties and the like were improved even with the structure, 50% or more of which is constituted by “one-layer-one-grain”, by adding any one of Ca, Mn, or V to the dielectric main component BaTiO₃.

### PRIOR ART LITERATURE

### Patent Literature

Patent Literature 1: Japanese Patent Laid-open No. 2010-180124

### SUMMARY OF THE INVENTION

### Problems to be Solved by the Invention

However, it is difficult in practice to steadily obtain excellent electrical insulating properties and voltage endurance characteristics (electric field endurance strength) with an excellent yield. That is thought to be because an uneven surface of the internal electrode that sandwiches a dielectric layer causes a dielectric breakdown of the dielectric layer due to a concentrated electric field at a convex part of the electrode. Because a multi-layer ceramic capacitor is considered equivalent to an electric circuit containing the same number of individual capacitors as the laminated layers connected in parallel where each capacitor constitutes an individual dielectric layer, even a short circuit of a single dielectric layer makes the entire capacitor electrically conductive. Thus, it is preferable to have a flat surface of an internal electrode layer to constantly obtain high insulating properties and voltage endurance characteristics.

The present invention was intended to solve the above problems, and an object of the present invention is to provide a multi-layer ceramic capacitor and method for manufacturing the same by flattening a surface of an internal electrode being laminated on a dielectric layer under appropriate conditions to achieve both high capacitance and reliability improvement at the same time.

### Means for Solving the Problems

The present invention is a multi-layer ceramic capacitor including: a dielectric layer and an internal electrode layer alternately laminated, wherein more than 50% of dielectric grains constituting the dielectric layer exists in one-layer-one-grain form, and an average value of an electrode-grain aspect ratio of electrode grains constituting the internal electrode layer is larger than 3, where the electrode-grain aspect ratio represents a ratio of a maximum grain length, which is perpendicular to the thickness direction, to a maximum grain thickness of the electrode grains.

In addition, an individual layer thickness of the dielectric layer is preferably equal to or less than 1 μm.

The present invention is also a method for manufacturing a multi-layer ceramic capacitor including: a step to prepare a dielectric material powder having an average grain size equal to or less than 100 nm; a step to fabricate a dielectric green sheet having a thickness equal to or less than 1 μm by applying the dielectric material powder; a step to print a conductive paste containing a metallic powder on the dielectric green sheet; a step to laminate the dielectric green sheet having the conductive paste printed thereon; and a step to sinter it in such a way that more than 50% of dielectric grains constituting a dielectric layer being made from a sintered dielectric green sheet is in one-layer-one-grain form, and that an average value of an electrode-grain aspect ratio of electrode grains constituting an internal electrode layer being made from a sintered conductive paste is higher than 3, where the electrode-grain aspect ratio represents a ratio of a maximum grain length, which is perpendicular to the thickness direction, to a maximum grain thickness of the electrode grains.

In addition, a method for manufacturing a multi-layer ceramic capacitor includes a step to disperse BaTiO₃ of grain size equal to or less than 50 nm as a common material in the conductive paste prior to printing on the dielectric green sheet, wherein a main component of the dielectric material powder is preferably BaTiO₃.

### Effects of the Invention

According to the present invention, an internal electrode surface being laminated on a dielectric sheet can be flattened to a suitable level in the manufacturing process of a multi-layer ceramic capacitor by controlling to have a one-layer-one-grain structure being more than 50% in the dielectric layer and to have an average electrode-grain aspect ratio being higher than 3 for the internal electrode layer. By doing this, high voltage endurance characteristics (electric field endurance strength) can be obtained even when a dielectric layer has a reduced thickness. When a thickness of the dielectric layer is equal to or less than 1 μm, the effect becomes particularly remarkable. Therefore, both high capacitance and reliability improvement of a multi-layer ceramic capacitor can be achieved at the same time.

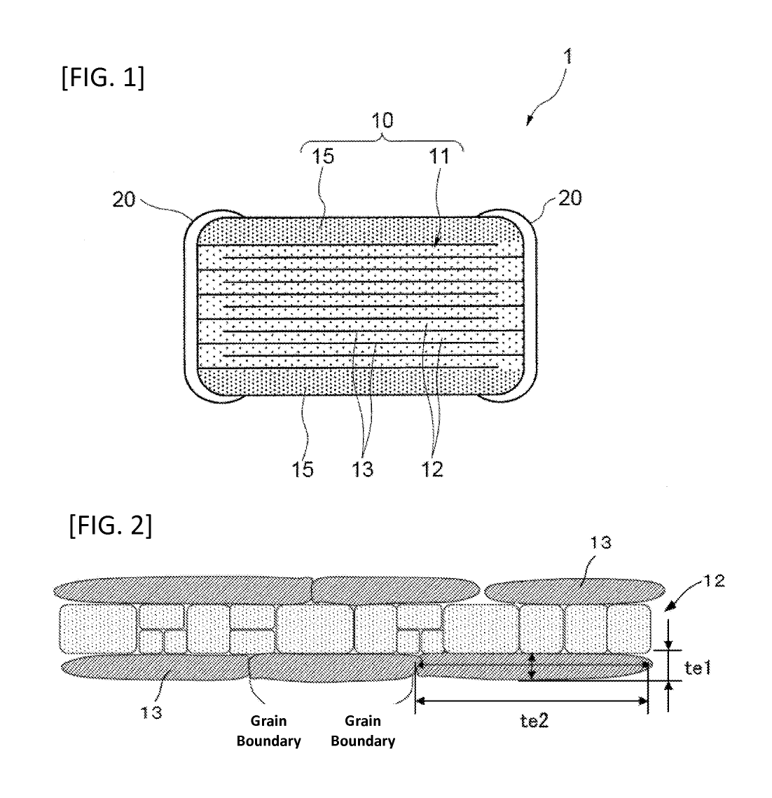

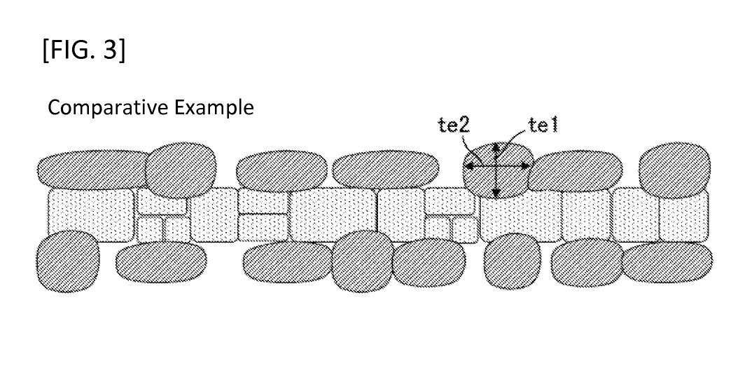

### BRIEF DESCRIPTION OF THE DRAWINGS

[FIG. 1] FIG. 1 is a schematic longitudinal section view of a multi-layer ceramic capacitor according to an embodiment of the present invention.

[FIG. 2] FIG. 2 is a section view of a dielectric layer and internal electrode layers of a multi-layer ceramic capacitor according to an embodiment of the present invention.

[FIG. 3] FIG. 3 is a section view of a dielectric layer and internal electrode layers of a multi-layer ceramic capacitor according to a comparative example that is not applicable to the present invention.

### DESCRIPTION OF THE EMBODIMENTS

A multi-layer ceramic capacitor according to an embodiment of the present invention is explained below. FIG. 1 is a schematic longitudinal section view of a multi-layer ceramic capacitor 1. Multi-layer ceramic capacitor 1 is roughly composed of a ceramic sintered compact 10 having standardized chip dimensions and shape (for example, a rectangular parallelepiped of 1.0×0.5×0.5 mm), and a pair of external electrodes 20 formed on both sides of ceramic sintered compact 10. Ceramic sintered compact 10 is made of BaTiO₃ (barium titanate), for example, as a main component and contains laminate 11 in which dielectric layer 112 and internal electrode layer 13 are alternately laminated, and cover layer 15 formed as top and bottom outermost layers in a stacking direction.

Laminate 11 has a high-density multi-layer structure of some hundreds of layers total with a single dielectric layer 12 having a thickness of 1 μm or less and being sandwiched between two internal electrode layers 13 according to the capacitance, required endurance, and the like in specifications. Dielectric layer 12 is also manufactured in a one-layer-one-grain structure where the dielectric grain size after sintering and the layer thickness are nearly equal. The degree of formation of one-layer-one-grain structure is expressed as proportion of dielectric grains existing in one-layer-one-grain form (one-layer-one-grain proportion) in dielectric layer 12. According to an embodiment of the present invention, the one-layer-one-grain proportion of a multi-layer ceramic capacitor is more than 50%.

Cover layer 15 formed as outermost layers in laminate 11 provides protection of dielectric layers 12 and internal electrodes 13 from moisture, contamination, and the like from outside, as well as prevention of deterioration over time.

Multi-layer ceramic capacitor 1 is manufactured as follows, for example. First, a dielectric material powder is prepared by wet-mixing a material powder having BaTiO₃ as a main component and grain size of approximately 100 nm or less, along with an additive compound, and drying and pulverizing the mixture. By finely pulverizing the dielectric material powder to approximately 100 nm or less, a conductive paste can be placed evenly and uniformly on a dielectric green sheet (mentioned later), thereby contributing to flattening of the internal electrode layer after sintering.

The prepared dielectric material powder is wet-mixed using polyvinyl acetal resin and an organic solvent, and a band-shaped dielectric green sheet of 1 μm or less is obtained by doctor blade method for example, and dried. Then, an internal electrode 13 pattern is arranged on the dielectric green sheet surface by screen printing a conductive paste containing an organic binder. In addition, Ni is preferably used as a metal powder for a conductive paste, for example. Also, BaTiO₃ with a grain size of 50 nm or less may be evenly dispersed as a co-material. Due to BaTiO₃ contained as a common material, rapid calcining of the electrode grains is suppressed, and the aspect ratio increases by gradual grain growth in a layer direction.

Then, the dielectric green sheets that have been stamped out into 15 cm×15 cm size, for example, and aligned are alternately laminated with internal electrode layer 13 to the predetermined number of layers. Cover sheets to be cover layers 15 are pressure-bonded onto the top and bottom of the laminated dielectric green sheets, cut into the specified chip size (1.0 mm×0.5 mm, for example), and then the conductive paste to be external electrodes 20 is applied on both sides of the laminate and dried. A compact body of a multi-layer ceramic capacitor 1 is thereby obtained.

The compact body obtained in this manner is heated at approximately 350° C. in a N₂ ambience to remove the binder, followed by sintering at 1220 to 1280° C. in a mixed gas of N₂, H₂, and H₂O (oxygen partial pressure at approximately 1.0×10⁻¹¹ MPa) for 10 minutes to 6 hours. After the sintering, oxidation treatment of the dielectric sheet is carried out at approximately 1000° C. in a N₂ ambience for approximately one hour, thereby obtaining a multi-layer ceramic capacitor 1 having dielectric layers with grains grown to the desired grain size (refer to the average grain size after sintering as mentioned later in this specification).

According to an embodiment of the present invention, control is conducted in such a way that more than 50% of dielectric grains constituting dielectric layer 12 exist in one-layer-one-grain form and an average value of electrode-grain aspect ratios in internal electrode 13 becomes greater than 3 by using a dielectric material powder having BaTiO₃ with an average grain size 100 nm or less as a main component. In doing so, a multi-layer ceramic capacitor 1 having a high relative dielectric constant of 6000 or higher and a voltage endurance characteristics of over 50 V (electric field endurance strength of over 70 V/μm) is obtained when a dielectric layer thickness is 1 μm or less, for example, a thickness of approximately 0.7 μm.

### EXAMPLES

Next, examples of a multi-layer ceramic capacitor (hereinafter referred to as “MLCC”) according to the present invention are explained.

### <Manufacture of a MLCC>

### (1) Preparation of Dielectric Material Powder

First, high-purity BaTiO₃ powder with an average grain size 110 nm, 0.5 mol of HoO_{3/2}, 0.5 mol of SiO₂, 0.4 mol of MnCO₃ (becomes MnO as CO₂ dissociates when sintered), and 0.1 mol of ZrO₂, per 100 mol of BaTiO₃, were prepared for a dielectric material powder by weighing each compound. An average grain size of the material powder was obtained by performing SEM analysis on a barium titanate powder sample and finding a median size using the sample number of 500. Then, the dielectric material powder was prepared by wet-mixing with water, drying, and dry-pulverizing the material powder of each sample as shown in Table. 1. Dielectric material powder used for cover layers was also prepared using a similar constituent compounds.

### (2) Manufacture of a MLCC Compact

The prepared dielectric material powder was wet-mixed using polyvinyl acetal resin and an organic solvent, and a dielectric green sheet of thickness 1 μm by doctor blade method was obtained, and dried. A ceramic cover sheet used as a cover layer was made to have a thickness of 10 μm. An internal electrode was arranged on the dielectric green sheet by screen printing Ni-conductive paste in a specified pattern. 101 dielectric green sheets having the arranged electrode pattern were laminated so that the number of laminated dielectric layers, n, was 100, and then 20 cover sheets, each having a 10-μm thickness, were pressure-bonded on both top and bottom sides of the laminate, thereby obtaining a sample of MLCC compact.

### (3) Sintering of a MLCC Compact

The MLCC compact sample was heated at 350° C. in a N₂ ambience to remove the binder, and then sintered at 1220 to 1280° C. in a mixed gas of N₂, H₂, and H₂O (oxygen partial pressure at approximately 1.0×10⁻¹¹ MPa) for 10 minutes to 6 hours. The sintering temperature and time were adjusted as appropriate to obtain a grain size for a one-layer-one-grain structure. After sintering, oxidation treatment of the dielectric sheet was carried out at 1000° C. in a N₂ ambience for one hour. The dielectric layer thickness after calcination was approximately 0.71 μm.

### MLCC Evaluation Method

### (1) Grain Size Evaluation Method

A partial section of the MLCC was polished and extracted, and dielectric grain sizes were measured based on a photograph of the dielectric layer cross-section using a scanning electron microscope (SEM). “Grain size” is defined as an average of maximum dielectric grain lengths after sintering in a direction parallel to the internal electrode layer (i.e. direction perpendicular to the electric field) in this specification. As to sampling of dielectric grains for measuring grain size, the number for a sample was 500 grains or more. When an area of the observed site (e.g. a single photo at a magnification of 2000 by SEM) had 500 grains or more, all grains in the photo were measured. If less than 500 grains, the observation (capturing) was conducted at multiple areas so as to have 500 grains or more. In addition, thermal etching was performed on the grain interface with heat treatment at 1180° C. for 5 minutes in the same ambience (a mixed gas of N₂, H₂, and H₂O) as the sintering process beforehand to enhance the grain boundary lines in SEM photos.

### (2) Evaluation Method of One-Layer-One-Grain Proportion

One-layer-one-grain proportion was calculated by performing an image analysis of a dielectric layer cross-section photo taken with a scanning electron microscope (SEM). Here, FIG. 2 shows a schematic cross-section of dielectric layer 12 and internal electrode 13 of the multi-layer ceramic capacitor 1. One-layer-one-grain proportion was calculated by scanning in such a way that dielectric layer 12 is dissected with a constant width in a direction perpendicular to the stacking direction (i.e. horizontal direction in FIG. 2), and dividing the number of grains making contact with both above and below internal electrode layers (i.e. existing in one-layer-one-grain form) by the number of total dielectric grains detected with scanning. As to sampling, the number for a sample was 100 grains or more. When a single cross-section photo had 100 grains or more, all grains scanned in the photo were examined, and when less than 100 grains, a cross-section photo from another area was also examined to have 100 grains or more.

### (3) Evaluation Method of Electrode-Grain Aspect Ratio

Electrode-grain aspect ratio was calculated by performing an image analysis of an internal electrode layer cross-section photo taken with a scanning electron microscope (SEM). Here, FIG. 2 shows a cross-section of an individual layer having the electrode-grain aspect ratio (3≦te2/te1) in the range according to an embodiment of the present invention. On the other hand, FIG. 3 shows a cross-section of an individual layer from a comparative example that does not fall under the present invention (3>te2/te1). As shown in FIG. 2 and FIG. 3, grain boundaries exist in an internal electrode layer in a manner dissecting the layer thickness, and conductive body portions divided by the grain boundaries define electrode grains, respectively. “Electrode-grain aspect ratio” used in the evaluation is defined as the ratio of maximum width te2 separated by grain boundaries to maximum thickness of electrode grain te1 (electrode-grain aspect ratio=te2/te1). As to sampling for evaluating the electrode-grain aspect ratio, the number for a sample was 100 grains or more. When a single cross-section photo had 100 grains or more, examine all electrode grains in the photo, and when the number of grains was less than 100, a cross-section photo from another area was also sampled to have 100 grains or more.

### (4) Evaluation Method of Dielectric Constant

The MLCC that had been through oxidation treatment after sintering was placed in a thermostatic chamber at 150° C. and kept stationary for one hour and placed at room temperature 25° C. for 24 hours for conditioning, and then capacitance Cm was measured using an impedance analyzer. Applied voltage conditions for the measurement were 1 kHz and 1.0 Vrms. Relative dielectric constant ε was calculated using the following formula (1) with capacitance Cm from the measurement:

Cm=ε×ε₀×n×S/t formula (1)

Here, ε₀ is the dielectric constant of a vacuum; n, S, and t are the number of laminated dielectric layers, area of internal electrodes, and thickness of dielectric layers, respectively.

### (5) Evaluation Method of Voltage Endurance Characteristics (Electric Field Endurance Strength)

Endurance voltage is the voltage where dielectric breakdown occurs when DC voltage was applied increasingly starting at 0 V at room temperature 25° C. to the MLCC that had been through oxidation treatment after sintering. Electric field endurance strength is the value of this voltage divided by post-sintering dielectric layer thickness.

### <Evaluation Results of MLCC>

Evaluation results on dielectric layers of the MLCC manufactured under the above conditions are explained with reference to Table. 1.

TABLE 1

| | | Dielectric Layer | | | ε | |
|---|---|---|---|---|---|---|
| | Electrode Grain | One-Layer-One-Grain | Breakdown Strength | | Relative Dielectric | |
| | Aspect Ratio | Percentage | Voltage | Electric Field | Constant | *: Out of Specification |
| Sample No. | (—) | (%) | (V) | (V/μm) | (—) | (Reference Example) |
| 1 | 2.09 | 62 | 24 | 34 | 6620 | * AspectRatio TooSmall |
| 2 | 2.67 | 55 | 39 | 55 | 6370 | * Aspect Ratio Too Small |
| 3 | 2.91 | 71 | 46 | 65 | 7140 | * Aspect Ratio Too Small |
| 4 | 3.05 | 65 | 51 | 72 | 6980 | |
| 5 | 3.22 | 66 | 53 | 75 | 6900 | |
| 6 | 3.53 | 58 | 55 | 77 | 6470 | |
| 7 | 4.01 | 60 | 54 | 76 | 6490 | |
| 8 | 4.17 | 54 | 55 | 77 | 6330 | |
| 9 | 4.30 | 57 | 55 | 77 | 6410 | |
| 10 | 4.71 | 61 | 57 | 80 | 6530 | |
| 11 | 5.04 | 53 | 56 | 79 | 6190 | |
| 12 | 4.46 | 49 | 56 | 79 | 5930 | * One-Layer-One-Grain Percentage Too Small |
| 13 | 3.74 | 45 | 54 | 76 | 5770 | * One-Layer-One-Grain Percentage Too Small |
| 14 | 3.43 | 38 | 52 | 73 | 5200 | * One-Layer-One-Grain Percentage Too Small |
| 15 | 3.11 | 28 | 54 | 76 | 4030 | * One-Layer-One-Grain Percentage Too Small |
| 16 | 2.85 | 48 | 49 | 69 | 5960 | * Aspect Ratio Too Small |
| | | | | | | One-Layer-One-Grain Percentage Too Small |
| 17 | 2.17 | 33 | 30 | 42 | 4650 | * Aspect Ratio Too Small |
| | | | | | | One-Layer-One-Grain Percentage Too Small |
| 18 | 2.28 | 31 | 33 | 46 | 4420 | * Aspect Ratio TooSmall |
| | | | | | | One-Layer-One-Grain Percentage Too Small |

### (1) Samples No. 1 to 11

All of samples No. 1 to 11 are examples of dielectric layers having a one-layer-one-grain structure of one-layer-one-grain proportion of more than 50%. Among them, relative dielectric constant ε higher than 6000 and voltage endurance characteristics higher than 50 V (electric field endurance strength of over 70 V/μm) are confirmed in samples No. 4 to 11 which have an electrode-grain aspect ratio larger than 3.

All of samples No. 1 to 3 which had electrode-grain aspect ratios smaller than 3 showed endurance voltage below 50 V (electric field endurance strength below 70 V/μm).

### (2) Samples No. 12 to 15

Although samples No. 12 to 15 had an electrode-grain aspect ratio larger than 3, one-layer-one-grain proportion in the dielectric layer was less than 50%. In these samples, dielectric grains did not grow sufficiently resulting in all relative dielectric constants ε being below 6000.

### (3) Samples No. 16 to 18

All of samples No. 16 to 18 had electrode-grain aspect ratios below 3 as well as one-layer-one-grain proportion below 50%. As a result, the relative dielectric constants were below 50 V (electric field endurance strength of below 70 V/μm).

### DESCRIPTION OF THE SYMBOLS

1 Multi-layer ceramic capacitor
10 Ceramic sintered compact
11 Laminate
12 Dielectric layer
13 Internal electrode layer
15 Cover layer
20 External electrode

1. A multi-layer ceramic capacitor comprising:
dielectric layers; and
internal electrode layers alternately laminated with the dielectric layers,
wherein more than 50% of dielectric grains constituting the dielectric layers exist in one-layer-one-grain form where a thickness of one dielectric layer and a size of the dielectric grains are approximately equal, and an average value of an electrode-grain aspect ratio of electrode grains constituting the internal electrode layers is larger than 3, said electrode-grain aspect ratio representing a ratio of a maximum grain length, which is perpendicular to the thickness direction, to a maximum grain thickness of the electrode grains.

2. The multi-layer ceramic capacitor according to claim 1, wherein an individual layer thickness of the dielectric layer is equal to or less than 1 μm.

3. A method for manufacturing a multi-layer ceramic capacitor comprising:
a step to prepare a dielectric material powder having an average grain size equal to or less than 100 nm;
a step to fabricate a dielectric green sheet having a thickness equal to or less than 1 μm by applying the dielectric material powder;
a step to print a conductive paste containing a metallic powder on the dielectric green sheet;
a step to laminate the dielectric green sheet having the conductive paste printed thereon; and
a step to sinter the laminate in such a way that more than 50% of dielectric grains constituting a dielectric layer being made from a sintered dielectric green sheet is in one-layer-one-grain form, and that an average value of an electrode-grain aspect ratio of electrode grains constituting an internal electrode layer being made from a sintered conductive paste is higher than 3, said electrode-grain aspect ratio representing a ratio of a maximum grain length, which is perpendicular to the thickness direction, to a maximum grain thickness of the electrode grains.

4. The method for manufacturing a multi-layer ceramic capacitor according to claim 3, further comprising:
a step to disperse BaTiO₃ of a grain size equal to or less than 50 nm as a co-material in the conductive paste prior to printing on the dielectric green sheet, wherein a main component of the dielectric material powder is BaTiO₃.
